(19) United States
(12) Patent Application Publication
(10) Pub. No.: US 2005/0005794 A1
(43) Pub. Date: Jan. 13, 2005

(54) Coating method and planographic printing plate

(75) Inventors: Yuzoh Inukai, Shizuoka (JP); Hiromu Ando, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/858,408

(22) Filed: Jun. 2, 2004

(30) Foreign Application Priority Data
Jun. 5, 2003 (JP) 2003-160692
Jun. 5, 2003 (JP) 2003-160693

(51) Int. Cl. B05D 3/02

(52) U.S. Cl. 101/453; 430/300; 427/372.2; 427/402

(57) ABSTRACT

The present invention provides a method of coating a coating solution comprising: providing a web; providing a coating solution; coating the coating solution on at least one surface of the web; and drying the coating solution to form a coated layer, wherein a temperature of the web is maintained at 35° C. or more during coating. According to the coating method, a multi-layered planographic printing plate can be manufactured at low energy cost and running cost.

### CROSS-REFERENCE TO RELATED APPLICATION

This application claims priority under 35 USC 119 from Japanese Patent Application Nos. 2003-160692 and 2003-160693, the disclosures of which are incorporated by reference herein.

### BACKGROUND OF THE INVENTION

1. Field of the Invention

The present invention relates to a coating method and to a planographic printing plate, in particular to a coating method that can considerably shorten the time required for a coating solution coated on a web to dry, and to a planographic printing plate in which a plate-making layer is formed by means of this coating method. Furthermore, the invention relates in particular to a coating method that, whatever variations in width and in thickness of the web occur, can reliably maintain the standard time required for a coating solution which has been coated to dry, and to a planographic printing plate in which a plate-making layer is formed according to this coating method.

2. Description of the Related Art

A planographic printing plate is normally manufactured by coating a photosensitive layer forming solution on a grained surface of a support web that has been obtained by graining at least one surface of an aluminum web, and thereafter heating and drying the surface to form a plate-making layer.

In the past, various kinds of methods have been proposed for drying a photosensitive layer forming solution coated on a support web.

Among such methods can be cited a method in which a support web, on which a photosensitive layer forming solution has been coated, is brought into contact with a heating roll maintained at a predetermined temperature (Japanese Patent Application Laid-Open (JP-A) No.04-70837); a method in which hot air is blown from a slit-shaped nozzle to dry a photosensitive layer forming solution (JP-A No.07-89255); a method in which infrared light is irradiated to dry a photosensitive layer forming solution (JP-A No.06-317896); and a method in which, in a latter half of a process of drying a photosensitive layer forming solution, a heating roll is brought into contact with a support web in order to dry the photosensitive layer forming solution (Japanese Patent Application Publication (JP-B) No.06-63487 and JP-A Nos.08-318198 and 09-66259).

Furthermore, a method has been proposed in which, after moisture has been removed from a surface of a support web by heating and drying, the support web is cooled in an atmosphere of which dew point is 10° C. or less, and thereby moisture is inhibited from sticking again on a surface of the support web (JP-A No.11-170722).

Still furthermore, a method has been proposed in which a photosensitive layer is dried under particular drying conditions (JP-A Nos.2001-125255 and 2001-117219).

In recent years, direct plate-making has gone onto the commercial market in which plate-making is performed by directly scanning and exposing a planographic printing plate with visible laser light, or with infrared laser light.

Among planographic printing plates used in the manufacture of direct plate making, that is, as direct printing plates, there is a photo-polymerizing type planographic printing plate that has, as a plate-making layer, for instance, a photo-polymerizing type laser-sensitive layer in which an ethylenically unsaturated compound, a polymer binder and a photo-polymerization initiator are compounded, the plate-making layer being provided with an oxygen barrier layer that protects the photo-polymerizing type laser-sensitive layer from oxygen in the air.

Thus, unlike in the case of the conventional planographic printing plates, in the case of a direct printing plate it is common to laminate multiple layers with different functions, such as laminating a protective layer on a surface of a plate-making layer. Furthermore, there is a direct printing plate in which on a surface of a support web, a heat-shielding layer, a first plate-making layer, a photo-thermal conversion layer and a second plate-making layer are formed, in that order.

In the case of a direct printing plate, in order to form multiple layers, it is common to repeat a number of times a process of forming a coated layer by coating, on a support web, a predetermined coating solution such as a plate-making layer forming solution, an intermediate layer forming solution and an oxygen barrier layer forming solution, and thereafter heating and drying the coated layer. Accordingly, demands are being made for a coating solution film, which is the film of a coating solution coated on a support, to be dried more rapidly than in the past.

However, when a coating solution is merely coated on a support web and thereafter dried, in an initial stage of drying a portion of the heat supplied is partially consumed by the process of raising the temperature of the support web and the coating solution film. Furthermore, the transfer of heat to the support web is normally performed through a convection heat transfer. Accordingly, since it takes time to raise a temperature of the support web and the coating solution film, the time required for drying becomes longer.

As a result, in order to dry the coating layer rapidly, it is necessary to raise a drying temperature, or to use a drying unit of larger size, in order to accelerate the rise in temperature of the support web and the coating solution film. However, simply raising the drying temperature, or increasing the size of the drying unit, leads to increases in the costs of equipment, in energy costs and in operating costs (the first and most important problem with the conventional drying unit).

In the case of an existing manufacturing line being remodeled for use in manufacturing direct printing plates, it is extremely difficult to increase the size of a drying unit, and, in most cases, the existing drying unit has to be used almost as it is. In other words, in many cases, it is in practical terms impossible to increase the speed of drying by making the unit larger.

Furthermore, in addition to the first problem described above, the following problem exists in existing drying units.

Depending on the thickness and width of a support web, the time taken for the temperature to rise varies. That is, the thicker and wider the support web are, the longer a time it takes to raise the temperature.

However, in a normal manufacturing line, the drying time in a drying unit is set at a standard (certain) level. Accordingly, depending on the thickness and width of the support web, the extent to which a photosensitive layer of the support web emerging from the drying line has dried may not be constant.

As mentioned above, since it takes a longer period of time before temperatures of the support web and the photosensitive layer forming solution film rise, there is a possibility that the thicker and wider the support web is, variations, in particular in the degree of drying, become more pronounced. As a result, planographic printing plates obtained display variations in performance (the second most important problem with the conventional drying unit).

### SUMMARY OF THE INVENTION

In order to solve the first and most important problem mentioned above, the present invention provides a coating method that can be applied to production of a multi-layered planographic printing plate such as a direct printing plate and enables the manufacture of a planographic printing plate of this type with reductions in both energy costs and operating costs; and a planographic printing plate manufactured according to this coating method.

Furthermore, in order to solve the second and most important problem, the invention provides a coating method that can maintain, at a standard (certain) level, a time required for a coating solution such as a photosensitive layer forming solution to dry, even when the width and thickness of a web such as a support web have changed; and a planographic printing plate manufactured according to this coating method.

A first aspect of the invention is to provide a method of coating a coating solution comprising: providing a web; providing a coating solution; coating the coating solution on at least one surface of the web; and drying the coating solution to form a coated layer, wherein a temperature of the web is maintained at 35° C. or more during coating.

According to the coating method based on the first aspect, in an initial stage of drying, the amount of heat consumed in raising a temperature of the web and the coating solution film can be significantly reduced, or eliminated completely. Accordingly, the period of time necessary for raising the temperature of the support web and the coating solution film can be substantially reduced, or made almost zero; and accordingly, the time required for drying can be substantially reduced.

When, as in the manufacture of the direct printing plate, the processes of coating, and of heating and drying the coating solution are repeatedly applied, this coating method can be preferably applied.

A coating method with these characteristics can be preferably applied in a case where many coating layers are formed on a surface of a web. Accordingly, in addition to the manufacture of direct printing plates, in which multiple layers are formed on the support web, such as a direct printing plate that has a plate making layer and a protective layer (and an intermediate layer as needs arise), and the direct printing plate in which the heat-shielding layer, the first plate-making layer, the photo-thermal conversion layer and the second plate-making layer are disposed, in that order, as described above in the “Description of the Related Art”, the present coating method can be preferably applied to manufacture magnetic tapes such as audio tapes and video tapes, photographic films and various kinds of color iron sheets.

In addition to the support web described in the “Description of the Related Art”, among webs can be cited a base film for magnetic tapes, a base film for photographic films and a zinc plated steel plate used in the manufacture of color iron sheets.

Furthermore, the coating solution may be either a water-based coating solution or an organic solvent-based coating solution. Among coating solutions which can be cited are a plate-making layer forming solution, an intermediate layer forming solution and an oxygen barrier layer forming solution, solutions used to manufacture the direct printing plate that has a plate-making layer and a protective layer (and a intermediate layer, as needs arise).

In addition to the above, among other coating solutions which can be cited are various kinds of coating solutions used to manufacture a direct printing plate in which a first plate-making layer, a photo-thermal conversion layer and a second plate-making layer are formed in that order; a negative (type) photosensitive layer forming solution used to form a negative photosensitive layer in the manufacture of a photosensitive planographic printing plate; and a positive (type) photosensitive layer forming solution used to form a positive photosensitive layer.

Furthermore, among other coatings that can be cited are a magnetic layer forming solution, a protective layer forming solution and an abrasive layer forming solution used in the manufacture of magnetic tapes, the respective layer coating solutions for forming layers such as a red photosensitive layer, a green photosensitive layer, a blue photosensitive layer, an intermediate layer and a yellow filter layer in a photographic film, and an undercoat, an intermediate coat and an overcoat used in the manufacture of color iron sheets.

An appropriate method of maintaining a surface of the web at a temperature of 35° C. or more is a method of heating the web.

Furthermore, in a case where two or more coating layers are formed on the web, as will be described later, after the initial coating layer has been formed, heated and dried, the support web which has been heated and dried may be cooled to a temperature in the above-described range by an appropriate method.

Examples of the method of heating the web to a temperature in the aforementioned range before a coating solution is coated include hot-air heating in which hot air is blown onto the web, roller heating in which the web is brought into contact with a heating roller, infrared irradiation in which infrared light is irradiated onto the web, and induction heating in which the web is heated by an induction current generated by applying an alternate magnetic field to the web. Among these heating methods, roller heating is the most preferable from the viewpoint of high heat transfer efficiency secured by means of contact heat transfer.

Examples of the method of drying the coating solution coated on the web include, similarly to the case of the method of heating the web to a temperature in the aforementioned range before a coating solution is coated, hot air heating, roller heating, infrared light irradiation and induction heating. However, since in the case of hot air heating a coating solution film is dried with a solvent vapor blowing off a heated surface of the coating solution film, the coating solution film can be dried within a short time, and for this reason hot air heating is preferable.

When the coating solution coated on the web is dried, a surface of the web on which the coating solution has been coated may face upwards or downwards. However, when the coating solution is dried by means of hot air heating, or by infrared light irradiation, it is necessary to blow hot air, or to irradiate infrared light, onto the surface coated.

When the heating roller is used to dry the coating solution, and when induction heating, i.e., an induction heating roller, is used to heat the web, the heating roller or the induction-heating roller need to be brought into contact with a surface opposite to the surface on which the coating solution has been coated.

In a second aspect of the invention, the coating method of the first aspect further includes a process of maintaining, when the coating solution is coated on at least one surface of the web, a temperature of the surface of the web in a range of 35° C. to 0.8 Tb_{low} (° C.), Tb_{low} being a boiling temperature in terms of centigrade lowest among boiling temperatures of solvents contained in the coating solution.

In a method based on this aspect, a web is maintained at a temperature in a range lower than 0.8 Tb_{low} (° C.). Accordingly, a solvent in the coating solution film can with certainty be inhibited from boiling as soon as the coating solution is coated onto the web, thereby preventing the formation of vaporization marks of the solvent on the coating film. This is particularly preferable from the point of view of obtaining a coated film superior in terms of uniformity, and with fewer defects.

The temperature of 0.8 Tb_{low} (° C.) should preferably be higher than 35° C. in terms of inhibiting the solvent in the coating solution film from boiling. Accordingly, a boiling point of the solvent in the coating solution is preferably higher than 35÷0.8=43.75° C.

In this connection, a temperature of the web at a time when a coating solution is coated is preferably in the range of 35° C. or more, and 0.75 Tb_{low} (° C.) or less. The temperature of 0.75 Tb_{low} (° C.) is preferably more than 35° C. and accordingly a boiling point of the solvent in the coating solution is particularly preferably higher than 46.67° C.

According to a third aspect of the invention, the web is brought into contact with a heating roller to maintain a temperature of 35° C. or more.

In the coating method described above, since the heating roller transfers heat to the web by means of contact heat transfer, heat conduction efficiency is high. Accordingly, the web is pre-heated rapidly, whereby the amount of heat consumed in raising the temperatures of the web and the coating solution film during the initial stages of drying can be particularly effectively reduced, and the coating solution film can be dried particularly rapidly.

In a fourth aspect of the invention, the coating method of the first aspect further includes: a first process of coating a first coating solution followed by drying, thereby forming a first coated layer; and a second process of coating a second coating solution superposed on the first coated layer formed during the first coating process and subsequent drying, thereby forming a second coated layer superposed on the first coated layer, wherein, during both the first and second coating processes, the first and second coating solutions are coated with a temperature of the web maintained at 35° C. or more.

The coating method based on this aspect is a coating method by which two or more layers of coated film are formed on a web, and whenever the first coated layer is formed and thereafter the second coated layer is formed, the web is maintained at a temperature of 35° C. or more. Accordingly, the time required for each of the coated layers to dry can be substantially abbreviated. The coating method based on the present aspect can be particularly preferably used, when two or more coated layers are formed to manufacture a direct printing plate such as the photo-polymerizing type planographic printing plate described in the “Description of the Related Art”, can be particularly preferably used.

In a fifth aspect of the invention, in the first coating process according to the fourth aspect, the first coating process includes a process of heating and drying the web on which the first coating solution has been coated, thereby forming a first coated layer; and the second coating process includes a process of cooling the web heated and dried during the first coating process, thereby maintaining a temperature of a surface of the web at a temperature of 35° C. or more.

According to the coating method based on this aspect, by making use of heat that has been used to heat and dry the first coating solution coated onto the web during the first coating process, in the second coating process a surface temperature of the web is controlled. Accordingly, energy costs can be more effectively reduced.

Among methods of cooling the web on which the first coated layer has been formed, in addition to a method of blowing cold air, there is a method of bringing the web into contact with a cooling roller.

In a sixth aspect of the invention, in the second coating process, cold air is blown to cool a surface of the web on which the first coated layer has been formed during the first coating process.

According to the coating method based on this aspect, the surface of the web can be cooled to a predetermined temperature without bringing the cooling roller into contact with the surface of the web on which the first coated layer has been formed. Accordingly, during the process of cooling, the first coated layer is neither bruised nor damaged.

A seventh aspect of the invention is to provide a planographic printing plate, comprising: a support web obtained by graining at least one surface of an aluminum web; a plate-making layer formed on the grained surface of the support web; and a protective layer that is superposed on the plate-making layer and protects the plate-making layer, wherein the plate-making layer and the protective layer are formed by coating and drying respectively a plate-making layer forming solution and a protective layer forming solution, with a surface temperature of the support web maintained at a temperature of 35° C. or more.

In the planographic printing plate based on this aspect, by applying the coating method described in the “Description of the Related Art”, the plate-making layer and the protective layer are formed.

Accordingly, since the period of time required from coating to drying the plate-making layer forming solution and the protective layer forming solution can be substantially reduced, manufacture can be achieved at lower operating costs and lower energy costs.

Among plate-making layers can be cited a photo-polymerizing type laser-sensitive layer in which, for instance, an ethylenically unsaturated compound, a polymer binder and a photo-polymerization initiator are blended.

Among protective layers can be cited an oxygen barrier layer, which is made of an oxygen barrier resin such as polyvinyl alcohol and protects the photo-polymerizing type laser-sensitive layer from oxygen in the air.

In an eighth aspect of the invention, the planographic printing plate of the seventh aspect includes an intermediate layer between the plate-making layer and the protective layer. The intermediate layer is formed by coating and drying an intermediate layer forming solution with the support web maintained at a temperature of 35° C. or more.

The planographic printing plate based on this aspect is an example where, in a planographic printing plate having a plate-making layer, an intermediate layer and a protective layer, the coating method according to the invention is applied to form the intermediate layer. In this method, times required for drying not only the plate-making layer and the protective layer but also the intermediate layer can be substantially reduced. Accordingly, manufacture can be achieved at lower operating costs and at lower energy costs.

As in the case of the oxygen barrier layer, a layer made of an oxygen barrier resin can be cited as an example of the intermediate layer.

In a ninth aspect of the invention, the planographic printing plate of the seventh aspect is formed such that a temperature of the support web is maintained, when the plate-making layer forming solution and the protective layer forming solution are coated, at a temperature in the range of 35° C. to 0.8 Tb_{low} (° C.).

In a tenth aspect of the invention, the planographic printing plate of the seventh aspect is formed such that a temperature of the support web is maintained, when the intermediate layer forming solution is being coated, at a temperature in the range of 35° C. to 0.8 Tb_{low} (° C.).

In the planographic printing plate based on these aspects, a plate-making layer forming solution, an intermediate layer forming solution and a protective layer forming solution are coated with a surface of the support web maintained at a temperature in the range of lower than 0.8 Tb_{low} (° C.). Accordingly, it is possible to prevent with certainty the occurrence of accidents in which, as soon as coating solutions have been coated, a solvent in a coating solution boils and a vaporization mark of the solvent is thereby caused on the coated film. Because of this, the plate-making layer, the intermediate layer and the protective layer in the planographic printing plate are all superior in terms of homogeneity, and there are fewer defects.

Furthermore, in the planographic printing plate, when the plate-making layer forming solution, the intermediate layer forming solution and the protective layer forming solution are coated, a surface temperature of the planographic printing plate is particularly preferably maintained at a temperature in the range of lower than 0.75 Tb_{low} (° C.).

In an eleventh aspect of the invention, the plate-making layer of the planographic printing plate is a photo-polymerizing type laser-sensitive layer that is polymerized by exposure to visible light, or to ultraviolet light, and the protective layer is an oxygen barrier layer that protects the photo-polymerizing type laser-sensitive layer from oxygen in the air.

The planographic printing plate is an example of a planographic printing plate where the photo-polymerizing type laser-sensitive layer and the oxygen barrier layer are formed according to the coating method based on the first through sixth aspects.

According to a twelfth aspect of the invention, the intermediate layer is a layer of oxygen barrier resin having oxygen barrier properties.

The planographic printing plate based on this aspect is an example in which, in the planographic printing plate based on the eleventh aspect, an intermediate layer made of an oxygen barrier resin is disposed.

Furthermore, a thirteenth aspect of the invention is to provide a coating method in which, when the web is wider than a predetermined value, and/or thicker than a predetermined value, the coating solution is coated with a temperature of the web maintained at a temperature of 35° C. or more.

In a case where the thickness and width of the web are relatively large, when a coating solution is coated on a web at a normal temperature and thereafter heated and dried, in the initial stages of drying a large amount of heat is consumed in raising a temperature of the web and the coating solution film.

According to the coating method based on this aspect, in a case where the web is relatively thick and/or relatively wide, the coating solution is coated, with the web maintained at a relatively high temperature (35° C. or more). Thereby, the amount of heat consumed in raising the temperature of the web and the coating solution film can be substantially reduced, or even reduced to zero. As a result, the time required for drying can be substantially reduced.

In other words, as in a case where the web is thin and/or narrow, even in a case where the web is thick and/or wide, the coating solution film can be dried within a short period of time. Furthermore, the coating solution does not exhibit fluctuations in the extent to which it dries.

In the coating method according to this aspect, the coating solution coated on the web can be dried within a short period of time. Accordingly, when many coated layers are formed on a surface of the web, the coating method can be preferably applied. Accordingly, the coating method can be preferably applied to manufacture not only planographic printing plates but also magnetic tapes such as audiotapes and videotapes, photographic films, and various kinds of color iron sheets.

The web and the coating solution in this aspect are similar to those in various aspects described above, and explanations will accordingly be omitted.

Among methods of drying the coating solution coated on the web can be cited hot air heating, roller heating, infrared light irradiation and induction heating. However, hot air heating is preferably applied, insofar that drying is performed with solvent vapor blowing off a surface of the heated coating solution film, and the coating solution film can accordingly be dried within a short period of time.

When the coating solution coated on the web is dried, a surface of the web on which the coating solution has been coated may face upwards or downwards. However, in cases where hot air drying or infrared irradiation is used to dry the web, it is necessary to blow hot air, or to irradiate infrared light onto the coated surface. Furthermore, when a heating roller is used for drying the web, and when an induction heating roller is used for induction heating, the heating roller and the induction heating roller are necessarily brought into contact with a surface on the opposite side to the coated surface.

In a fourteenth aspect of the invention, the coating method according to the thirteenth aspect further includes a process of holding a temperature of the web at 0.8 Tb_{low} (° C.), or less (Tb_{low} is the lowest, expressed in terms of centigrade, of boiling points of solvents contained in the coating solution).

According to this aspect, the web is maintained at a temperature equal to 0.8 Tb_{low} (° C.) or less. Accordingly, the solvent in the coating solution film can with certainty be inhibited from boiling as soon as the coating solution is coated onto the web, thereby preventing the formation of vaporization marks of the solvent on the coating film. This is particularly preferable in terms of obtaining a coated film superior in uniformity, and with few defects.

Among methods of heating and maintaining the web in the temperature range described above, roller heating is the most preferable. Furthermore, when the coating layer is formed in two or more layers on the web, after an initial coating layer has been formed, a support web which has thus been heated and dried may be cooled to a temperature in the range mentioned above by an appropriate method.

A fifteenth aspect of the invention is to provide a planographic printing plate, comprising: a support web obtained by graining at least one surface of an aluminum web; and a plate-making layer formed on the grained surface of the support web, wherein the planographic printing plate is formed by coating the coating solution in either a state where a web is wider than a predetermined value, or in a state where the web is thicker than a predetermined value, or in both such states, and with a temperature of the web of the plate-making layer maintained at a temperature of 35° C. or more.

In the planographic printing plate of the present aspect, a plate-making layer is formed by effecting coating and drying of a plate-making layer forming solution by applying the coating method based on the thirteenth aspect.

According to the planographic printing plate based on this aspect, even when the support web is relatively thick and relatively wide, it is possible to abbreviate substantially the period of time required, after the plate-making layer forming solution and the protective layer forming solution have been coated, for raising a temperature of the support web to a drying temperature. Accordingly, the plate-making layer can be formed within a period of time, which is as short as that required for drying when the support web is relatively thin and relatively narrow. As a result, irrespective of variations in thickness and width of the support web, a planographic printing plate producing a constant performance can be obtained.

In a sixteenth aspect of the invention, the planographic printing plate of the fifteenth aspect is formed by coating the plate-making layer forming solution onto a support web maintained at a temperature equal to 0.8 Tb_{low} (° C.) or less, and thereafter drying the plate-making layer forming solution.

In the planographic printing plate according to this aspect, with a surface of the support web being maintained at a temperature in the range of lower than 0.8 Tb_{low} (° C.), the plate making layer forming solution, the intermediate layer forming solution and the protective layer forming solution are coated. Accordingly, the solvent in the coating solution film can with certainty be inhibited from causing an accident in which the solvent boils as soon as the coating solutions have been coated, whereby the formation of vaporization marks of the solvent on the coating film is prevented. As a result, the plate-making layer, the intermediate layer and the protective layer in the planographic printing plate all are superior in terms of uniformity, and with few defects.

In the planographic printing plate, when the plate-making layer forming solution, the intermediate layer forming solution and the protective layer forming solution are coated, a surface temperature of the planographic printing plate is particularly preferably maintained at a temperature in the range of lower than 0.75 Tb_{low} (° C.).

### BRIEF DESCRIPTION OF THE DRAWINGS

FIG. 1 is a schematic diagram showing one example of a manufacturing line that is used for manufacturing a planographic printing plate by use of a coating method according to the present invention.

FIG. 2 is a schematic diagram showing another example of a manufacturing line that is used for manufacturing a planographic printing plate by use of a coating method according to the invention.

FIG. 3 is a graph showing relationship between pre-heating temperature of a support web and drying time of a water-based coating solution in example 1 of an embodiment of the invention.

FIG. 4 is a graph showing relationship between pre-heating temperature of a support web and drying time of a photosensitive layer forming solution in example 2 of an embodiment of the invention.

FIG. 5 is a graph showing relationship between pre-heating temperature of a support web and drying time of a photo-polymerizing type laser-sensitive layer forming solution in example 3 of an embodiment of the invention.

FIG. 6 is a graph showing relationship between pre-heating temperature of a support web and drying time of a photosensitive layer forming solution in example 4 of an embodiment of the invention.

### DETAILED DESCRIPTION OF THE INVENTION

In the following, each of constituent elements of a planographic printing plate, in which a plate making layer is formed according to a coating method of an embodiment of the present invention, will be detailed.

1. Support Web

As a support web, one that is obtained by roughening at least one surface of an aluminum web as a band like sheet of pure aluminum or aluminum alloy, is used.

An aluminum web can be roughened by applying following various processes in an order of, for instance, a mechanical roughening process→an alkali etching process (1)→a desmutting process (1)→an electrical etching process→an alkali etching process (2)→a desmutting process (2). Between the respective consecutive processes, a process of water rinse is preferably inserted.

In the mechanical roughening process, brush graining may be carried out in which, with an aluminum web transferring in a constant direction, an abrasive is blown onto a surface of the aluminum web, followed by scrubbing the web surface with a roller-like nylon brush.

In the alkali etching process, alkali etching can be effected by spraying an alkali solution such as caustic soda on both surfaces or at least a roughened surface of the aluminum web. In the alkali etching process (1) and the alkali etching process (2), concentration, composition and temperature of the alkaline solution used may be different.

In the desmutting process, desmutting can be effected by spraying an acidic solution such as hydrochloric acid and nitric acid on both surfaces or at least a roughened surface of the aluminum web. In the electrical etching process described below, black oxide of the component contained by a small amount, which is generally called smut, precipitates on a surface of the aluminum web. The smut is removed by applying the desmutting process. In the desmutting process (1) and the desmutting process (2), concentrations, types, compositions and temperatures of the acidic solutions used may be different from each other.

In the electrical etching process, usually, the aluminum web is exposed to alternating-current electrolysis in an acidic electrolytic solution. As an acidic electrolytic solution, diluted hydrochloric acid and diluted nitric acid are mainly used. The electrical etching process may be applied only once or twice or more.

After the electrical etching process is over, anodization is applied to the aluminum web, and subsequently a treatment for making the surface hydrophilic (which treatment will be referred to as “hydrophilic treatment” for convenience hereinafter) may be carried out with a water glass solution and so on.

As the pure aluminum and aluminum alloy, for instance, JIS A 1050 material, JIS A 3103 material, JIS A 3005 material, JIS A 1100 material, JIS A 3004 material all described in ARUMINIUMU HANDBOOK, 4th EDITION (1990, KEIKINZOKU KYOUKAI) and alloys obtained by adding 5% by weight or less of magnesium to the above aluminum materials to increase the tensile strength can be cited. Furthermore, reused aluminum also can be used.

2. Plate Making Layer

As the plate making layer, there are two types which are: a visible light exposure type photosensitive layer that is exposed with visible light; and a laser exposure type photosensitive layer that is irradiated with laser light for exposure.

(1) Visible Light Exposure Type Photosensitive Layer

The visible light exposure type photosensitive layer can be formed of a composition that contains a photosensitive resin and optionally a coloring agent and so on.

Examples of the photosensitive resin include a positive-type photosensitive resin that becomes soluble to a developer after being exposed to light and a negative-type photosensitive resin that becomes insoluble to the developer after being exposed to light.

Examples of the positive-type photosensitive resin include combinations of diazide compounds (such as quinone azide compounds and naphtoquinone azide compounds) and phenolic resins (such as phenol novolac resins and cresol novolac resins) can be cited.

On the other hand, examples of the negative photosensitive resin include: a combination of a diazo compound and a binder, examples of the diazo compound including a diazo resin as a condensate of aromatic diazonium salt and an aldehyde such as formaldehyde, an inorganic acid salt of the diazo resin, and an organic acid salt of the diazo resin, examples of the binder including (meth)acrylate resin, polyamide resin and polyurethane; and a combination of a vinyl polymer such as (meth)acrylate resin and polystyrenic resin, a vinyl polymeric compound such as (meth)acrylate and styrene, and a photo-polymerization initiator such as benzoin derivative, benzophenone derivative and thioxanthone derivative.

As the coloring agent, in addition to ordinary dyes, exposure coloring dyes that develop color when exposed, and exposure discoloring dyes that become almost or completely colorless when exposed can be used.

As the exposure coloring dye, for instance, leuco dyes and so on can be cited.

As the exposure discoloring dye, triphenyl methane based dyes, diphenyl methane based dyes, oxazine based dyes, xanthane based dyes, iminonaphtoquinone based dyes, azomethine based dyes and anthraquinone based dyes can be cited.

By coating a photosensitive resin solution in which the photosensitive resin and the coloring agent are dissolved in a solvent, followed by drying, the visible light exposure type photosensitive layer can be formed.

Examples of the solvent that can be used in the photosensitive resin solution include solvents that dissolve the photosensitive resins and have a certain extent of volatility at room temperature can be cited. Specifically, for instance, alcohol based solvents, ketone based solvents, ester based solvents, ether based solvent, glycol ether based solvents, amide based solvents and carbonic ester based solvents.

As the alcohol based solvent, ethanol, propanol and buthanol can be cited. As the ketone based solvent, acetone, methyl ethyl ketone, methyl propyl ketone, methyl isopropyl ketone and diethyl ketone or the like can be cited. As the ester based solvent, ethyl acetate, propyl acetate, methyl formate and ethyl formate can be cited. As the ether based solvent, tetrahydrofuran and dioxane can be cited, and as the glycol ether based solvent, ethyl cellosolve, methyl cellosolve and butyl cellosolve can be cited. As the amide based solvent, dimethyl formaldehyde and dimethylacetamide can be cited. As the carbonic ester based solvent, ethylene carbonate, propylene carbonate, diethyl carbonate and dibutyl carbonate can be cited.

(2) Laser Exposure Type Photosensitive Layer

As the laser exposure type photosensitive layer, a negative laser-sensitive layer in which a laser-irradiated portion remains after exposure and development, a positive laser-sensitive layer in which a laser-irradiated portion is removed, and a photo-polymerizing type laser-sensitive layer that photo-polymerizes upon irradiation of the laser light can be mainly cited.

A. Negative Laser-Sensitive Layer

The negative laser-sensitive layer can be formed of a negative laser-sensitive layer forming solution in which (A) an acid precursor that decomposes in the presence of heat or light to generate an acid, (B) an acid-crosslinking compound that cross-links owing to the acid generated by the decomposition of the acid precursor (A), (C) an alkali-soluble resin, (D) an infrared absorbent and (E) a phenolic hydroxy group containing compound are dissolved or suspended in an appropriate solvent.

Examples of the acid precursor (A) include compounds that decompose to generate sulfonic acid in the presence of UV light, visible light or heat, such as an iminophosphate compound. In addition to these, compounds that are generally used as cationic photo-polymerization initiator, radical photo-polymerization initiator, or photo-inductive alterant also can be used as the precursor (A).

As the acid-crosslinking compound (B), aromatic compounds that have at least one of an alkoxymethyl group and a hydroxyl group, compounds that have a N-hydroxy methyl group, a N-alkoxymethyl group, or a N-acyloxy methyl group, and epoxy compounds can be cited.

As the alkali-soluble resin (C), novolac resins and polymers that have a hydroxyaryl group on a side chain such as poly(hydroxystyrene) can be cited.

As the infrared absorbent (D), dyes and pigments that absorb infrared light in the range of 760 to 1200 nm can be cited. Specifically, black pigments, red pigments, metal powder pigments, phthalocyanine based pigments, and azo dyes, anthraquinone dyes, phthalocyanine dyes and cyanine dyes that absorb infrared light having the above wavelength can be cited.

As the phenolic hydroxy group-containing compound (E), compounds represented by a general formula (R₁—X)ₙ-Ar-(OH)ₘ (R₁ denotes an alkyl group or an alkenyl group that have 6 to 32 carbon atoms; X, a terminal bond, O, S, COO, or CONH; Ar, an aromatic hydrocarbon group, an alicyclic hydrocarbon group or a heterocyclic group; and n and m each, a natural number of 1 to 3.) can be cited. As the compound, specifically, alkyl phenols such as nonyl phenol can be cited.

To the negative laser-sensitive layer forming solution, a plasticizer and so on can be further added.

B. Positive Laser-Sensitive Layer

The positive laser-sensitive layer can be formed of a positive laser-sensitive layer forming solution in which (F) an alkali-soluble polymer, (G) an alkali dissolution inhibitor, and (H) an infrared absorbent are dissolved or suspended in an appropriate solvent.

Examples of the alkali-soluble polymer (F) include: phenolic polymers having a phenolic hydroxy group such as phenol resins, cresol resins, novolac resins, pyrogallol resins and poly(hydroxystyrene); sulfonamide group-containing polymers in which at least a portion of monomer unit has a sulfonamide group; and active imide group-containing polymers that can be obtained by homopolymerization or copolymerization of monomer having an active imide group such as a N-(p-toluenesulfonyl)(meth)acrylamide group.

Examples of the alkali dissolution inhibitor (G) include compounds that, upon heating and so on, react with an alkali-soluble polymer (F) to lower the alkali solubility of the alkali-soluble polymer (F). Specifically, sulfone compounds, ammonium salts, sulfonium salts and amide compounds can be cited. In the case of, for instance, the novolac resin being used as the alkali-soluble polymer (F), a cyanine dye that is one kind of sulfone compounds can be preferably used as the alkali dissolution inhibitor (G).

As the infrared absorbent (H), dyes, colors, and pigments that have an absorption region in an infrared region of 750 to 1200 nm and have the photo-thermal conversion ability such as squarilium dyes, pyrylium dyes, carbon black, insoluble azo colors, anthraquinone based colors can be cited.

C. Photo-Polymerizing Type Laser-Sensitive Layer

The photo-polymerizing type laser-sensitive layer can be formed with a photo-polymerizing type laser sensitive layer forming solution that contains (I) a vinyl polymerizable compound having an ethylenically unsaturated bond at a molecule end. In the photo-polymerizing type laser-sensitive layer forming solution, in addition to the above, (J) a photo-polymerization initiator, (K) a sensitizer, and (L) a binder resin can be blended.

Examples of the vinyl polymerizable compound (I) include: polyvalent esters of ethylenically unsaturated carboxylic acid that are esters of ethylenically unsaturated carboxylic acids such as (meth)acrylic acid, itaconic acid and maleic acid and aliphatic polyhydric alcohols; and polyvalent amides of ethylenically unsaturated carboxylic acid such as methylene bis(meth)acryl amide and xylene (meth)acryl amides that are made of the ethylenically unsaturated carboxylic acids and polyvalent amines.

As the vinyl polymerizable compound (I), in addition to the above, aromatic vinyl compounds such as styrene and α-methyl styrene; and monoesters of ethylenically unsaturated carboxylic acid such as methyl (meth)acrylate and ethyl (meth)acrylate can also be used.

Furthermore, a dimmer or a trimer of vinyl-based monomers, as well as macromolecular vinyl monomer such as an oligomer, such as polyvalent esters of ethylenically unsaturated carboxylic acids, polyvalent amides of ethylenically unsaturated carboxylic acids, aromatic vinyl compounds and monoesters of ethylenically unsaturated carboxylic acids can also be used.

As the photo-polymerization initiator (J), photo-polymerization initiators that are usually used in photo-polymerization of vinyl monomer can be used.

As the sensitizer (K), titanocene compounds, triazine compounds, benzophenone based compounds, benzoimidazole based compound, cyanine dyes, melocyanine dyes, xanthane dyes and cumarine dyes can be cited.

As the binder (L), vinyl polymers obtained by homopolymerizing or copolymerizing vinyl monomers described in the vinyl polymerizable compounds (I), acidic cellulose derivatives having a carboxylic acid group on a side chain, urethanic binder polymers, polyvinyl pyrrolidone, polyethylene oxides, alcohol-soluble polyamides, and polyether of 2,2-bis-(4-hydroxyphenyl)-propane and epichlorohydrin can be cited.

Solvents that are used in the negative laser-sensitive layer forming solution, the positive laser-sensitive layer forming solution, or the photo-polymerizing type laser-sensitive layer forming solution, and coating methods of the negative laser-sensitive layer forming solution, the positive laser-sensitive layer forming solution, or the photo-polymerizing type laser-sensitive layer forming solution are the same as solvents and coating methods described in “(1) Visible light exposure type photosensitive layer” and thus the detailed descriptions thereof will be omitted.

In a case in which the photo-polymerizing type laser-sensitive layer is formed, when the roughened surface of the planographic printing plate support is pre-treated with a silicone compound having a reactive functional group such as a partially decomposed silane compound obtained by partially decomposing a silane compound with water, alcohol, or carboxylic acid, the adhesiveness between the planographic printing plate support and the photo-polymerizing type laser-sensitive layer can be preferably improved.

4. Intermediate Layer and Oxygen Barrier Layer

In the case of a photo-polymerizing type laser-sensitive layer being formed as a photosensitive layer, it is preferable that either an oxygen barrier layer is formed on the photo-polymerizing type laser-sensitive layer; or an intermediate layer is formed on the photo-polymerizing type laser-sensitive layer, and an oxygen barrier layer is formed on the intermediate layer.

The intermediate layer is a non-adhesive layer formed on the photo-polymerizing type laser-sensitive layer, i.e., a layer that has a function of inhibiting the photo-polymerizing type laser-sensitive layer from becoming sticky and thereby inhibiting the photo-polymerizing type laser-sensitive layer from adhering to a surface of a conveyance roller. On the other hand, the oxygen barrier layer, which is formed on the intermediate layer, has a function of protecting the photo-polymerizing type laser-sensitive layer from oxygen in air.

For the intermediate layer, any resin that can inhibit the photo-polymerizing type laser-sensitive layer from adhering to a surface of a conveyance roller and is excellent in the adhesiveness with the oxygen barrier layer can be used. However, as in the oxygen barrier layer, an oxygen barrier resin high in the oxygen barrier properties is preferably used in order to leave no pin holes in the oxygen barrier layer so that the photo-polymerizing type laser-sensitive layer is reliably protected from oxygen in air and ensure excellent adhesion with the oxygen barrier layer.

Specific examples of the oxygen barrier resin that can be used as the intermediate layer and the oxygen barrier layer include water-soluble polymers such as polyvinyl alcohol, vinyl alcohol/vinyl phthalate copolymer, vinyl acetate/vinyl alcohol/vinyl phthalate copolymer, vinyl acetate/crotonic acid copolymer, polyvinyl pyrrolidone, acidic celluloses, gelatin, gum Arabic, polyacrylic acid and polyacryl amide. These can be used singly or in blend. Among these water-soluble polymers, in view of the oxygen barrier properties and removability in development, polyvinyl alcohol is the most preferable.

As the oxygen barrier resin, in addition to the above, those that are generally known as high in the oxygen barrier properties such as vinylidene chloride resins (e.g., vinylidene chloride/vinyl chloride copolymer resin, vinylidene chloride/vinyl acetate copolymer resin), and ethylene/vinyl alcohol copolymer resin, can be cited.

A portion of hydroxyl groups of a vinyl alcohol unit may be substituted by ester, ether and acetal, or the polyvinyl alcohol may have a form of a copolymer of vinyl alcohol with other monomer, insofar that it has an enough number of unsubstituted vinyl alcohol units to impart necessary oxygen barrier properties and the water solubility.

As specific examples of polyvinyl alcohol, ones that are hydrolyzed by 71 to 100% and have a repeating unit of polymerization in the range of 300 to 2400 can be cited. Specifically, ones manufactured by Kuraray Co., Ltd. such as PVA-105, PVA-110, PVA-117, PVA-117H, PVA-120, PVA-124, PVA-124H, PVA-CS, PVA-CST, PVA-HC, PVA-203, PVA-204, PVA-205, PVA-210, PVA-217, PVA-220, PVA-224, PVA-217EE, PVA-217E, PVA-220E, PVA-224E, PVA-405, PVA-420, PVA-613 and L-8 can be cited.

The type of the oxygen barrier resin can be determined in consideration of, in addition to the desired oxygen barrier properties and removability in development, the fogging property and the adhesion with the photo-polymerizing type laser-sensitive layer and the oxygen barrier layer. Furthermore, in the intermediate layer, an oxygen barrier resin which is of the same type as that of the oxygen barrier layer may be used. Alternatively, an oxygen barrier resin of a different type may be used. Use of the oxygen barrier resin which is of the same type as that of the oxygen barrier layer is preferable because then the adhesion of the intermediate layer with the oxygen barrier layer becomes excellent. However, between the intermediate layer and the oxygen barrier layer, molecular weights of the oxygen barrier resins thereof may be different.

The oxygen permeation coefficients of the oxygen barrier resins that are used in the intermediate layer and the oxygen barrier layer are appropriately in the range of 1×10⁻¹⁶ to 1×10⁻¹⁰ cm³·cm/cm²·sec·cmHg, and particularly preferably in the range of 1×10⁻¹⁵ to 1×10⁻¹¹ cm³·cm/cm²·sec·cmHg. The molecular weight of the oxygen barrier resin is preferably in the range of 2000 to 10 million and particularly preferably in the range of 20,000 to 3 million.

The intermediate layer and the oxygen barrier layer can be formed by coating an intermediate layer forming solution and an oxygen barrier layer forming solution, a main component of which is a solution or an emulsion of the oxygen barrier resin, followed by drying. However, as the intermediate layer forming solution and the oxygen barrier layer forming solution, those that do not adversely affect on the already formed photo-polymerizing type laser-sensitive layer is preferably used.

For instance, when a water-soluble polymer is used as a polymer binder, an organic solvent solution of vinylidene chloride resin can be preferably used as an intermediate layer forming solution.

When an organic solvent-soluble polymer is used as a polymer binder, an aqueous solution of polyvinyl alcohol and polyvinyl pyrrolidone, or an emulsion of vinylidene chloride resin can be preferably used as the intermediate layer forming solution.

When glycerin, dipropylene glycol or the like is further added to the intermediate layer forming solution and the oxygen barrier layer forming solution, by several percents by weight with respect to the oxygen barrier resin, the obtained intermediate layer can be imparted with the flexibility.

Furthermore, when an anionic surfactant such as sodium alkyl sulfate and sodium alkyl sulfonate; an amphoteric surfactant such as alkylamino carboxylate and alkylamino dicarboxylate; or a nonionic surfactant such as polyoxyethylenealkylphenyl ether is added, by several percents by weight with respect to the oxygen barrier resin, the coating properties can be improved.

Still furthermore, in the case of a water-soluble polymer such as polyvinyl alcohol being used as the oxygen barrier resin, in order to improve the adhesion with the photo-polymerizing type laser-sensitive layer, acrylic emulsion or water-insoluble vinyl pyrrolidone/vinyl acetate copolymer may be added by 20 to 60% by weight with respect to the oxygen barrier resin.

5. Manufacturing Line

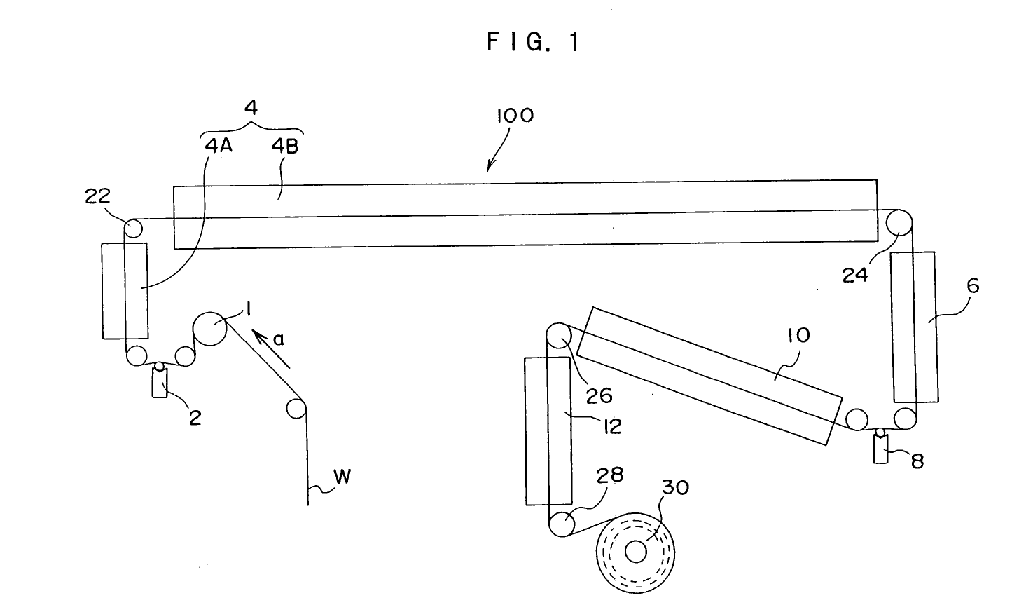

In FIG. 1, an example of a manufacturing line that is used to manufacture a planographic printing plate according to the invention is shown.

A manufacturing line 100, as shown in FIG. 1, includes a first coating portion 2 that coats a photo-polymerizing type laser-sensitive layer forming solution along a conveyance direction a of a support web W; a first drying portion 4 that dries a layer of the photo-polymerizing type laser-sensitive layer forming solution coated at the first coating portion 2 to form a photo-polymerizing type laser-sensitive layer; a first cooling portion 6 that cools the support web W passed through the first drying portion 4; a second coating portion 8 that coats a water-based coating solution, a main ingredient of which is an aqueous solution of an oxygen barrier resin, on a surface of the photo-polymerizing type laser-sensitive layer of the support web W gone through the first cooling portion 6; a second drying portion 10 that dries the water-based coating solution coated at the second coating portion 8 to form an oxygen barrier layer; a second cooling portion 12 that cools the support web W gone through the second drying portion 10; and a winding portion 30 that winds a planographic printing plate P gone through the second cooling portion 12.

On an up-stream side of the first coating portion 2, a pre-heating roller 1 is disposed to pre-heat a support web W. Furthermore, the first drying portion 4 is divided into a first drying tunnel 4A on an upstream side and a second drying tunnel 4B on a downstream side.

Between the first drying tunnel 4A and the second drying tunnel 4B on a downstream side, a conveyance roller 22 is disposed, and between the second drying tunnel 4B and the first cooling portion 6, a conveyance roller 24 is disposed. Furthermore, between the second drying portion 10 and the second cooling portion 12, a conveyance roller 26 is disposed, and between the second cooling portion 12 and the winding portion 30, a conveyance roller 28 is disposed.

The support web W is heated with a pre-heating roller 1 to a surface temperature of 35° C. or more, preferably to substantially 35 to 80° C. In the first coating portion 2, a photo-polymerizing type laser-sensitive layer forming solution is coated on a roughened surface of the support web W, and the coated photo-polymerizing type laser-sensitive layer forming solution is dried by use of the first drying tunnel 4A and the second drying tunnel 4B.

The support web W drawn out of the second drying tunnel 4B is such high in temperature as 100° C.; that is, the photo-polymerizing type laser-sensitive layer formed on the surface thereof is in a state of softened film and liable to be bruised. However, the support web is cooled to substantially 60 to 80° C. during going through the first cooling portion 6.

In the second coating portion 8, a water-based coating solution is further coated on the photo-polymerizing type laser-sensitive layer of the support web W gone through the first cooling portion 6 and dried in the second drying portion 10, and thereby a layer of oxygen barrier resin is formed. Here, as the water-based coating solution, among the intermediate layer forming solution and the oxygen barrier layer forming solution, water-based one can be cited.

In the manufacturing line 100, in the first coating portion 2 and the second coating portion 8, a bar coater is used; however, in place of the bar coater, various kinds of coating machines such as a slide bead coater, an extrusion coater and a roll coater may be used.

Furthermore, as the bar coater, either a bar coater having a forward-rolling bar that rolls in the same direction as the conveyance direction of the support web W or a bar coater having a reverse-rolling bar that rolls in a direction opposite to the conveyance direction of the support web W may be used.

There is no particular restriction on a method of heating the pre-heating roller 1; that is, heating due to pressurized steam, heating due to electric heat, heating due to heating medium and heating due to an induction coil all can be used. Furthermore, an arrangement in which a heater is disposed at the center of the heating roller 1 and the heating roller 1 is adapted to heat the surroundings thereof is preferable because then the inertial mass of the heating roller 1 can be reduced.

In the first drying portion 4 and the second drying portion 10, hot air drying may be applied. A flow of hot air may be a flow in parallel with a conveyance direction a of the support web W or a flow vertical to a conveyance direction a.

The water-based coating solution is preferably coated so that a dry film weight may be 0.5 to 5 g/m², and particularly preferably coated so that the dry film weight may be 1 to 3 g/m².

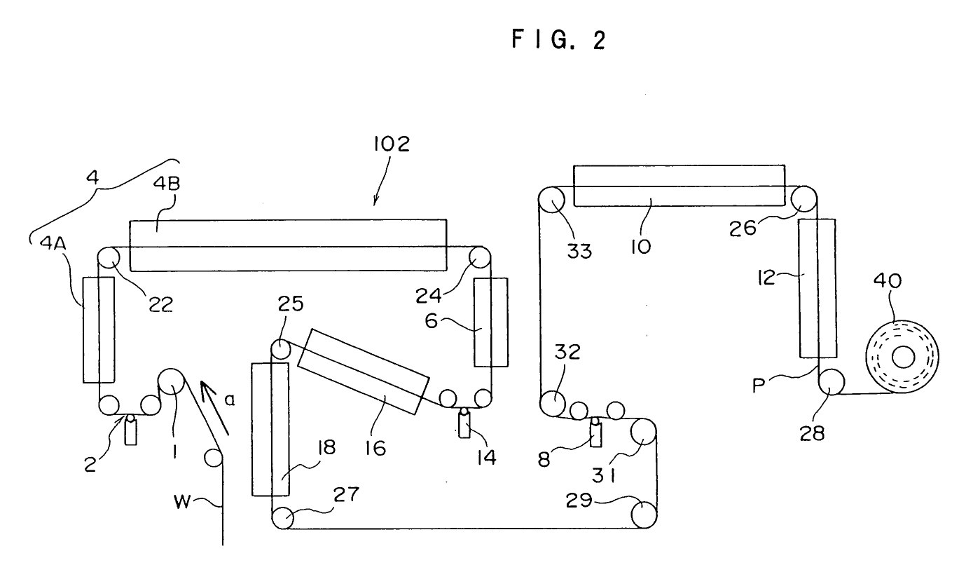

In FIG. 2, another example of a manufacturing line that is used to manufacture a planographic printing plate according to the invention is shown. In FIG. 2, the same reference numerals as those in FIG. 1 denote constituent elements the same as that in FIG. 1.

In a manufacturing line 102, as shown in FIG. 2, between a first cooling portion 6 and a second coating portion 8, there are provided a third coating portion 14 where an intermediate layer forming solution is coated, a third drying portion 16 that dries the intermediate layer forming solution coated at the third coating portion 14 and a third cooling portion 18 that cools the support web W gone through the third drying portion 16.

Between the third drying portion 16 and the third cooling portion 18, a conveyance roller 25 is disposed, and between the third cooling portion 18 and the second coating portion 8, conveyance rollers 27, 29 and 31 are disposed. Furthermore, between, the second coating portion 8 and the second drying portion 10, conveyance rollers 32 and 33 are disposed.

In FIG. 2, reference numeral 40 denotes a winding portion that winds a planographic printing plate P manufactured in the manufacturing line 102.

In the third coating portion 14, a bar coater is used; however, instead of the bar-coater, various kinds of coaters such as a slide bead coater, an extrusion coater and a roll coater can be used.

Except for the above points, the manufacturing line 102 has the same configuration and function as that of the manufacturing line 100.

The support web W is heated with the pre-heating roller 1 to a surface temperature of 35° C. or more, specifically to a temperature of substantially 35 to 80° C.

When a thickness of the support web W is relatively thicker (that is, when the thickness is larger than a predetermined value) and a width thereof is relatively wider (that is, when the width is wider than a predetermined value) and when the support web W is pre-heated as mentioned above, it can be particularly effectively heated.

At the first coating portion 2, a photo-polymerizing type laser-sensitive layer forming solution is coated on a roughened surface of the support web W, and the coated photo-polymerizing type laser-sensitive layer forming solution is dried in the first drying tunnel 4A and the second drying tunnel 4B.

The support web W drawn out of the second drying tunnel 4B is such high in temperature as substantially 100° C.; that is, the photo-polymerizing type laser-sensitive layer formed on the surface thereof is in a state of softened film and liable to be bruised; however, it is cooled to substantially 35 to 80° C. during going through the first cooling portion 6.

In the third coating portion 14, an intermediate layer forming solution is further coated so as to be superposed on the photo-polymerizing type laser-sensitive layer on the support web W that is cooled to substantially 60 to 80° C. while going through the first cooling portion 6. The intermediate layer forming solution is dried at the third drying portion 16, and thereby an intermediate layer is formed. The support web W drawn out of the third drying portion 16 is cooled at the third cooling portion 18. A temperature of the support web W that has been just drawn out of the third drying portion 16 is substantially 100° C.; however, it is cooled to a temperature of substantially 35 to 80° C. at the third cooling portion 18.

In the second coating portion 8, an oxygen barrier layer forming solution is coated so as to be superposed on the intermediate layer of the support web W cooled at the third cooling portion 18, followed by drying in the second drying portion 10, whereby a layer of oxygen barrier resin is formed.

Thus formed planographic printing plate P is wound in roll at the winding portion 40.

### EXAMPLES

### Example 1

On a surface of an aluminum web having a thickness of 0.24 mm, after mechanical graining was applied thereto by means of a brush graining method, electrical graining was effected in an alternating current electrolytic bath. Subsequently, anodization was applied so that an amount of an anodization coating be 2 g/m², followed by rendering hydrophilic, and thereby a support web W was manufactured.

In the next place, by use of the manufacturing line shown in FIG. 1, a photo-polymerizing type laser-sensitive layer forming solution was coated on the roughened surface of the support web W and dried, whereby a photo-polymerizing type laser-sensitive layer was formed. A water-based coating solution was coated thereon to form an intermediate layer. The photo-polymerizing type laser-sensitive layer forming solution was coated so that a dry film weight thereof be 1.5 g/m² and the water-based coating solution was coated so that a coating weight thereof be 11.3 cc/m².

A temperature of a drying air in the first drying portion was set at 120° C. so that a drying temperature when the photo-polymerizing type laser-sensitive layer was coated, was 120° C.

Furthermore, in the second drying portion 10, a temperature of a drying air was set at 100° C. or 120° C. so that a drying temperature of the water-based coating solution was 100° C. or 120° C.

Without pre-heating the support web by means of the heating roller 1, the photo-polymerizing type laser-sensitive layer forming solution was coated. When the water-based coating solution was coated, an extent of cooling at the first cooling portion 6 was controlled so that a temperature of the support web W be set at a predetermined temperature, before coating of the water-based coating solution was carried out.

A surface temperature of the support web W drawn out of the first cooling portion 6 was measured with an infrared thermometer, and this temperature was taken as a temperature of the support web W. Prescriptions of a photo-polymerizing type laser-sensitive layer forming solution and a water-based coating solution are shown below.

(Prescription of Photo-Polymerizing Type Laser-Sensitive Layer Forming Solution)

| | |
|---|---|
| Ethylenically unsaturated compound | 1.5 parts by weight |
| (Pentaerythritol tetraacrylate) | |
| Polymer binder | 2.0 parts by weight |
| (linear copolymer (MW = 40,000) | |
| obtained by copolymerizing 20 mol % of methacryl | |
| and 80 mol % of methyl methacrylate) | |
| Sensitizer (one shown in [Formula 1]) | 0.15 parts by weight |
| Photo-polymerization initiator | |
| (one shown in [Formula 2]) | 0.2 parts by weight |
| ε-phthalocyanine dispersion | 0.02 parts by weight |
| Megafac F117 (R) | 0.03 parts by weight |
| (fluorinated nonionic surfactant, | |
| manufactured by Dainippon Ink | |
| and Chemicals, Incorporated) | |
| Methyl ethyl ketone | 9.0 parts by weight |
| Propylene glycol monomethyl ether acetate | 7.5 parts by weight |
| Toluene | 11.0 parts by weight |

Sensitizer 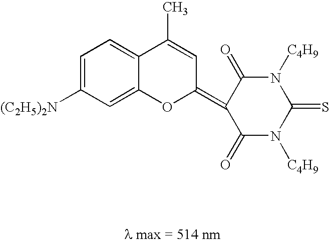
Photo-Polymerization Initiator

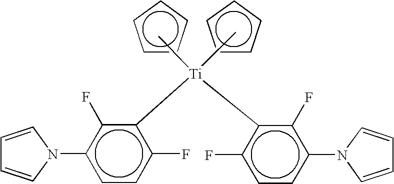

(Prescription of Water-Based Coating Solution)

| | |
|---|---|
| Polyvinyl alcohol | 20.0 parts by weight |
| (saponification degree: 98%, | |
| polymerization degree: 500) | |
| Polyvinyl pyrrolidone K30 | 2.0 parts by weight |
| (manufactured by Wako | |
| Pure Chemical Industries, Ltd.) | |
| Nonionic surfactant | 0.5 parts by weight |
| (EMALEX NP-10 (R), manufactured by | |
| Nihon Emulsion Co., Ltd.) | |
| Distilled water | 540 parts by weight |

A temperature of the water-based coating solution was 24 to 25° C.

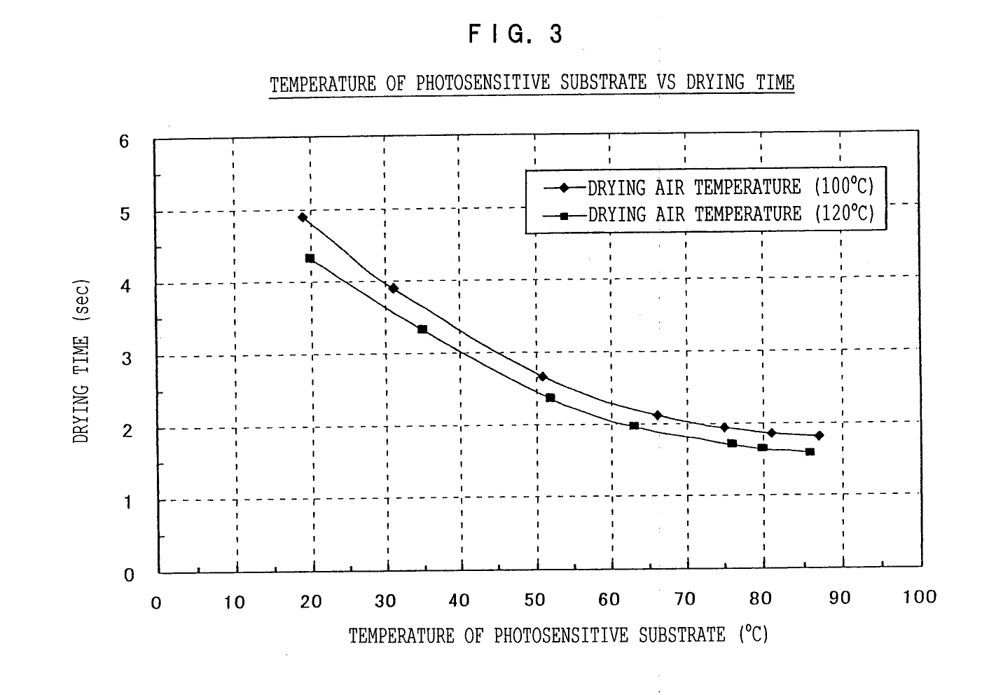

Results are shown in FIG. 3. “A photosensitive substrate” in FIG. 3 denotes a substrate in which a photo-polymerizing type laser-sensitive layer is formed on a support web W. Furthermore, determination of whether the water-based coating solution was dried or not was done, as follows: when a surface of the support web was scrubbed at the second coating portion and a portion more downstream side of the second coating portion, with a stick having cloth wound around a tip end thereof, a position where the water-based coating solution no longer adhered to the cloth and the luster of a coating film no longer changed was regarded as a “dried point”. As to a time required for dying (which time will occasionally be referred to as “drying time” hereinafter), a distance from an inlet of the second coating portion 10 to the drying point was measured, and the distance was divided by a conveyance speed of the support web W, thereby a drying time was obtained.

As shown in FIG. 3, when the water-based coating solution was coated on the support web heated at a temperature of less than 35° C., the drying time with the drying temperature being set at 100° C. was 3.5 sec or more, and the drying time with the drying temperature being set at 120° C. was 3.3 sec or more. On the other hand, when the water-based coating solution was coated on the support web heated at a temperature of 35° C. or more, when the drying temperature was 100° C., it took less than 3.5 sec, and when the drying temperature was 120° C., it took less than 3.3 sec.

Furthermore, when a temperature of the support web was 85 to 90° C., a slight trace presumably caused by evaporation of water was found on a layer coated with the water-based coating solution; however, when a temperature of the support web was 80 to 81° C., there was hardly found such trace, and when a temperature of the support web was less than 75° C., no trace was found.

From the above, it is found that a pre-heating temperature of a support web W is preferably from 35 to 80° C. or less and particularly preferably in the range of 35 to 75° C.

Here, since a boiling temperature of water, which is a solvent of the water-based coating solution, is 100° C., 80° C. that is an upper limit of the preferable pre-heating temperature is 0.8 times as large as the boiling temperature (in centigrade) of a solvent of the water-based coating solution. Accordingly, from results in FIG. 3, it is found that a preferable range of the pre-heating temperature of the support web W is 35° C. to 0.8Tb_{low} and particularly preferably in the range of 35 to 0.75Tb_{low}.

### Example 2

On a grained surface of a support web manufactured according to the similar procedure as that of Example 1, a photosensitive layer forming solution in which a positive photosensitive resin was blended as a photosensitive resin was coated and dried, by using the manufacturing line shown in FIG. 1. The prescription of the photosensitive layer forming solution is shown below.

(Prescription of Photosensitive Layer Forming Solution)

| | |
|---|---|
| Ester between | 0.9 parts by weight |
| 1,2-naphthoquinone-2-diazido-4-sulfonyl | |
| chloride and m-cresol formaldehyde resin | |
| (positive photosensitive resin) | |
| Cresol formaldehyde resin | 1.9 parts by weight |
| (positive photosensitive resin) | |
| Phthalic anhydride | 0.2 parts by weight |
| 4-[p-N-(p-hydroxybenzoyl)aminophenyl]- | 0.02 parts by weight |
| 2,6-bis (trichloromethyl)-S-triazine | |
| Victoria Pure Blue BOH | 0.03 parts by weight |
| (manufactured by Hodogaya Chemical Co., Ltd.) | |
| Megafac F-117 | 0.006 parts by weight |
| (fluorinated surfactant, manufactured by | |
| Dainippon Ink and Chemicals, Incorporated) | |
| Methyl ethyl ketone | 18 parts by weight |
| 1-methoxy-2-propanol | 15 parts by weight |

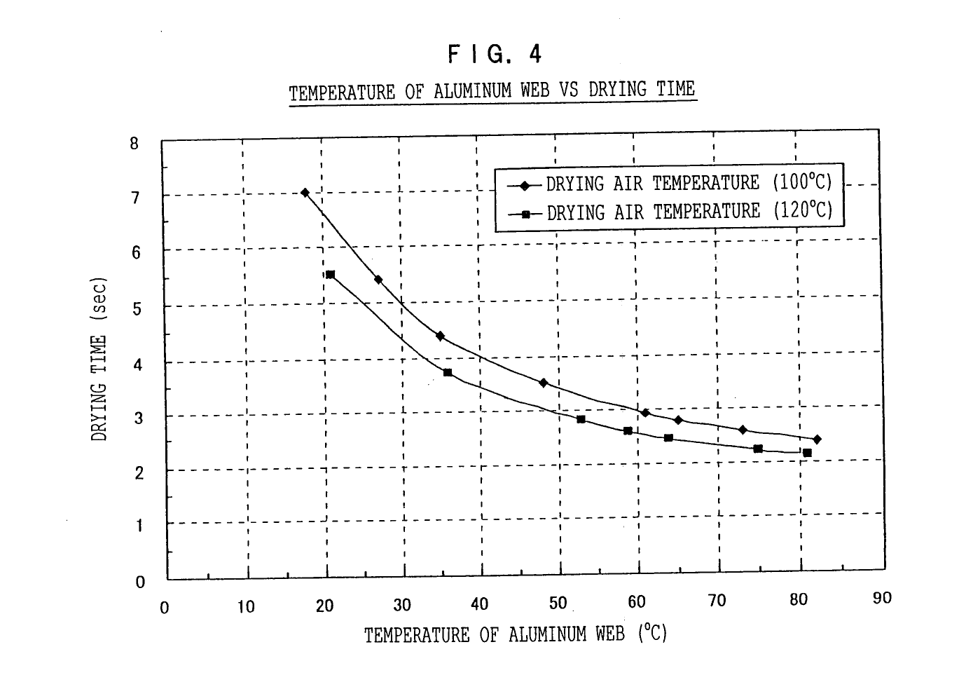

With a pre-heating temperature of a pre-heating roller 1 being set as shown in FIG. 4, a coating amount of the photosensitive layer forming solution in the first coating portion 2 being set at 18.8 cc/m² and a temperature of a hot air in the first drying portion 4 being set at 100° C./120° C., the photosensitive layer forming solution was coated. A temperature of the photosensitive layer forming solution was 24 to 25° C.

Determination of whether the photosensitive layer was dried or not was done, as follows: when a surface of the support web W was scrubbed at the first coating portion and a portion more downstream side of the first coating portion, with a stick having cloth wound around a tip end thereof, a position where the photosensitive layer forming solution no longer adhered to the cloth and the luster of a coating film no longer changed was regarded as a “dried point”.

As to a time required for dying (which time will occasionally be referred to as “drying time” hereinafter), a distance from an inlet of the first drying portion 4 to the drying point was measured, and the distance was divided by a conveyance speed of the support web W, thereby a drying time was obtained. Results are shown in FIG. 4.

As obvious from FIG. 4, when the photosensitive layer forming solution was coated on a support web heated at a temperature of less than 35° C., the drying time with the drying temperature being set at 100° C. was 4.5 sec or more, and the drying time with the drying temperature being set at 120° C. was 4 sec or more. On the other hand, when the photosensitive layer forming solution was coated on the support web heated at a temperature of 35° C. or more, when the drying temperature was 100° C., it took less than 4.5 sec, and when the drying temperature was 120° C., it took less than 3.8 sec.

Furthermore, when a temperature of the support web was in the vicinity of 85° C., a slight trace presumably caused by evaporation of the solvent was found on a photosensitive layer; however, when a temperature of the support web was 65° C., there was hardly found such trace, and when a temperature of the support web was less than 60° C., no trace was found.

From the above, it is found that a pre-heating temperature of a support web W is preferably in the range of 35 to 65° C. and particularly preferably in the range of 35 to 60° C.

Here, solvents blended in the photosensitive layer forming solution are methyl ethyl ketone and 1-methoxy-2-propanol, and the boiling temperatures thereof are 80° C. and 119° C., respectively.

Accordingly, among the solvents in the photosensitive layer forming solution, one having the lowest boiling temperature is methyl ethyl ketone and the boiling temperature thereof is 80° C.

Here, a range of the preferable pre-heating temperature of the support web W is 35 to 65° C., and particularly preferable range is 35 to 60° C. Accordingly, it is obvious from results of example 2 that a preferable range of the pre-heating temperature of the support web W is 35° C. to 0.8Tb_{low}, and particularly preferable range is 35° C. to 0.75Tb_{low}.

### Example 3

On surfaces of five types of aluminum webs each having a thickness of 0.15 mm, 0.20 mm, 0.24 mm, 0.30 mm, and 0.40 mm, the mechanical graining was applied according to the brush graining method, followed by applying the electrical graining in an alternating current electrolytic bath. Subsequently, the anodization was applied thereto so that an amount of an anodization coating was 2 g/m², followed by rendering the support web W hydrophilic. Support webs W were thus manufactured.

In the next place, by use of the manufacturing line shown in FIG. 1, a photo-polymerizing type laser-sensitive layer forming solution was coated on each of the roughened surfaces of the support webs W and dried, whereby photo-polymerizing type laser-sensitive layers were formed. On each thereof an intermediate layer forming solution was coated to form an intermediate layer.

The photo-polymerizing type laser-sensitive layer forming solution was coated so that an amount of coating solution was 18.8 cc/m² and a temperature of the hot air at the first drying portion was set at 120° C.

Furthermore, in the second drying portion 10, a temperature of a drying air was set at 100° C. or 120° C., and with the pre-heating temperature of the support web at the heating roller 1 being varied, the drying times were measured accordingly.

Determination of whether the photo-polymerizing type laser-sensitive layer forming solution was dried or not was done, as follows: when a surface of the support web W was scrubbed at the first coating portion and a portion more downstream side of the first coating portion, with a stick having cloth wound around a tip end thereof, a position where the photo-polymerizing type laser-sensitive layer forming solution no longer adhered to the cloth and the luster of a coating film no longer changed was regarded as a “dried point”. As to a time required for dying (which time will occasionally be referred to as “drying time” hereinafter), a distance from an inlet of the first drying portion 4 to the drying point was measured, and the distance was divided by a conveyance speed of the support web W, thereby a drying time was obtained. Prescriptions of the photo-polymerizing type laser-sensitive layer forming solution and the intermediate layer forming solution are shown below.

(Prescription of Photo-Polymerizing Type Laser-Sensitive Layer Forming Solution)

| | |
|---|---|
| Ethylenically unsaturated compound | 1.5 parts by weight |
| (Pentaerythritol tetraacrylate) | |
| Polymer binder | 2.0 parts by weight |
| (linear copolymer (MW = 40,000) obtained by | |
| copolymerizing 20 mol % of methacryl | |
| and 80 mol % of methyl methacrylate) | |
| Sensitizer (one shown in [Formula 1]) | 0.15 parts by weight |
| Photo-polymerization initiator | 0.2 parts by weight |
| (one shown in [Formula 2]) | |
| ε-phthalocyanine dispersion | 0.02 parts by weight |
| Megafac F117 (R) | 0.03 parts by weight |
| (fluorinated nonionic surfactant, | |
| manufactured by Dainippon Ink and | |
| Chemicals, Incorporated) | |
| Methyl ethyl ketone | 9.0 parts by weight |
| Propylene glycol monomethyl ether acetate | 7.5 parts by weight |
| Toluene | 11.0 parts by weight |

Sensitizer 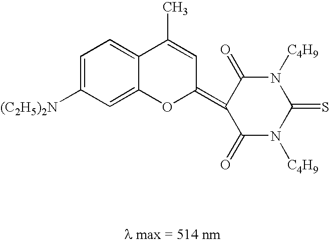
Photo-Polymerization Initiator

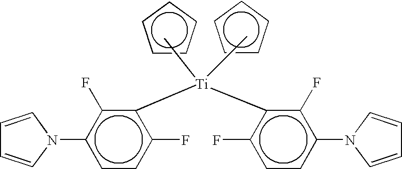

(Prescription of Intermediate Layer Forming Solution)

| | |
|---|---|
| Polyvinyl alcohol | 20.0 parts by weight |
| (saponification degree: 98%, | |
| polymerization degree: 500) | |
| Polyvinyl pyrrolidone K30 | 2.0 parts by weight |
| (manufactured by | |
| Wako Pure Chemical Industries, Ltd.) | |
| Nonionic surfactant (EMALEX NP-10 (R), | 0.5 parts by weight |
| manufactured by Nippon Emulsion Co., Ltd.) | |
| Distilled water | 540 parts by weight |

A temperature of the photo-polymerizing type laser-sensitive layer forming solution was 24 to 25° C.

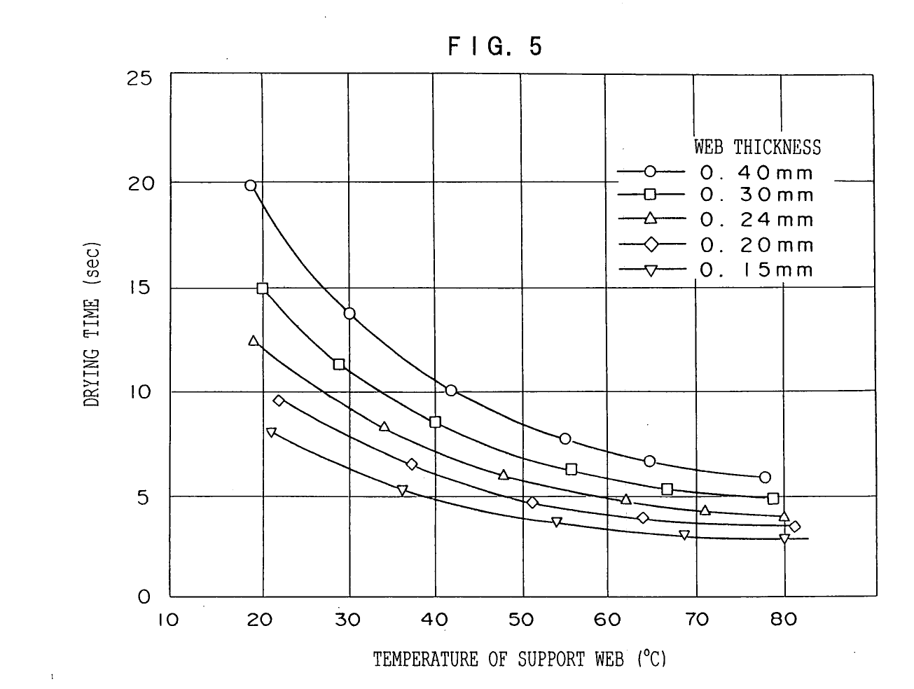

Results are shown in FIG. 5. When a pre-heating temperature of the support web W was in the vicinity of 80° C., in the obtained planographic printing plate, a slight trace caused by evaporation of the organic solvent was found; however, when a pre-heating temperature of the support web W was 70° C. or less, in the obtained planographic printing plate, there was hardly found such trace. Accordingly, it is found that a pre-heating temperature of a support web W is preferably 70° C. or less.

Here, among organic solvents contained in the photo-polymerization laser-sensitive layer forming solution, one that has the lowest boiling temperature is methyl ethyl ketone and the boiling temperature thereof. Tb_{low} is 80° C. Accordingly, 0.8Tb_{low} becomes 65° C. and this conforms to the above results.

Furthermore, from FIG. 5, the followings are found.

Firstly, in the case of a thickness of the support web W being varied, by controlling a pre-heating temperature of the support web in the pre-heating roller 1, the drying time can be made constant without necessity of varying a temperature of the hot air. In the case of the thickness of the support web being altered, for instance, from 0.15 mm through to 0.40 mm, in order to set the drying time at 8 sec, temperatures of the pre-heating roller 1 have only to be set as shown in Table 1.

TABLE 1

| | Thickness of support web (mm) | | | | |
|---|---|---|---|---|---|
| | 0.15 | 0.20 | 0.24 | 0.30 | 0.40 |
| Temperature of | 20 | 30 | 35.5 | 43 | 55 |
| pre-heating | | | | | |
| roller (° C.) | | | | | |

Since heat is transferred from the pre-heating roller 1 to the support web W through the conductive heat transfer, change in the temperature of the support web W due to the pre-heating roller 1 can be accomplished in a shorter time period than that in the case when the temperature of the support web W is changed by the change of the hot air condition.

In the case of the thickness of the support web W being thick, when the pre-heating temperature of the support web W cannot be set so high or so low because of the restriction on equipment of the manufacturing line; or when setting the pre-heating temperature of the support web W at a high temperature is not preferable in relation to the boiling point of an organic solvent contained in the photo-polymerizing type laser-sensitive layer forming solution, the temperature of the support web W may be changed by combining a change in temperature caused by the pre-heating roller 1 and a change of the hot air condition.

For instance, when the drying time is set at 5 sec in FIG. 5, as to the support webs W having thicknesses of 0.15 mm, 0.20 mm, 0.24 mm and 0.30 mm, a temperature of hot air is set at 120° C. and surface temperatures of the pre-heating roller 1 need be set so that the pre-heating temperatures of the support webs W may be 38, 48, 58 and 74° C., respectively.

On the other hand, as to the support web W having a thickness of 0.40 mm, when the drying time is tried to set at 5 sec only by the pre-heating of the support web W, the pre-heating temperature is necessary to be set at 80° C. or more. However, as mentioned above, when the pre-heating temperature of the support web W is in the vicinity of 80° C., evaporation marks of the organic solvent tend to be generated. Thus, it is preferable that the pre-heating temperature is set at 74° C. and the temperature of hot air is raised higher than 120° C.

In the case of the hot air temperature being 120° C., when the drying time is set at 12 sec, as to the support webs W having a thickness of 0.24 mm, 0.30 mm and 0.40 mm, surface temperatures of the pre-heating roller 1 need be set so that the pre-heating temperatures may be 22, 28 and 35° C., respectively.

On the other hand, as to the support webs having the thicknesses of 0.15 mm and 0.20 mm, since in the manufacturing line 100 the surface temperature of the pre-heating roller 1 cannot be set lower than room temperature, it suffices that the hot air temperature is lowered than 120° C.

### Example 4

On a grained surface of a support web that was manufactured according to the procedure similar to that of Example 3, a photosensitive layer forming solution in which a positive photosensitive resin was blended as a photosensitive resin was coated and dried by using the manufacturing line shown in FIG. 1. The prescription of the photosensitive layer forming solution is as follows.

(Prescription of Photosensitive Layer Forming Solution)

| | | |
|---|---|---|
| Ester between | 0.9 | parts by weight |
| 1,2-naphthoquinone-2-diazido-4- | | |
| sulfonylchloride and m-cresol formaldehyde resin | | |
| (positive photosensitive resin) | | |
| Cresol formaldehyde resin | 1.9 | parts by weight |
| (positive photosensitive resin) | | |
| Phthalic anhydride | 0.2 | parts by weight |
| 4-[p-N-(p-hydroxybenzoyl)aminophenyl]- | 0.02 | parts by weight |
| 2,6-bis(trichloromethyl)-S-triazine | | |
| Victoria pure blue BOH | 0.03 | parts by weight |
| (manufactured by Hodogaya Chemical Co., Ltd.) | | |
| Megafac F-117 | 0.006 | parts by weight |
| (fluorinated surfactant, manufactured by | | |
| Dainippon Ink and Chemicals, Incorporated) | | |
| Methyl ethyl ketone | 18 | parts by weight |
| 1-Methoxy-2-propanol | 15 | parts by weight |

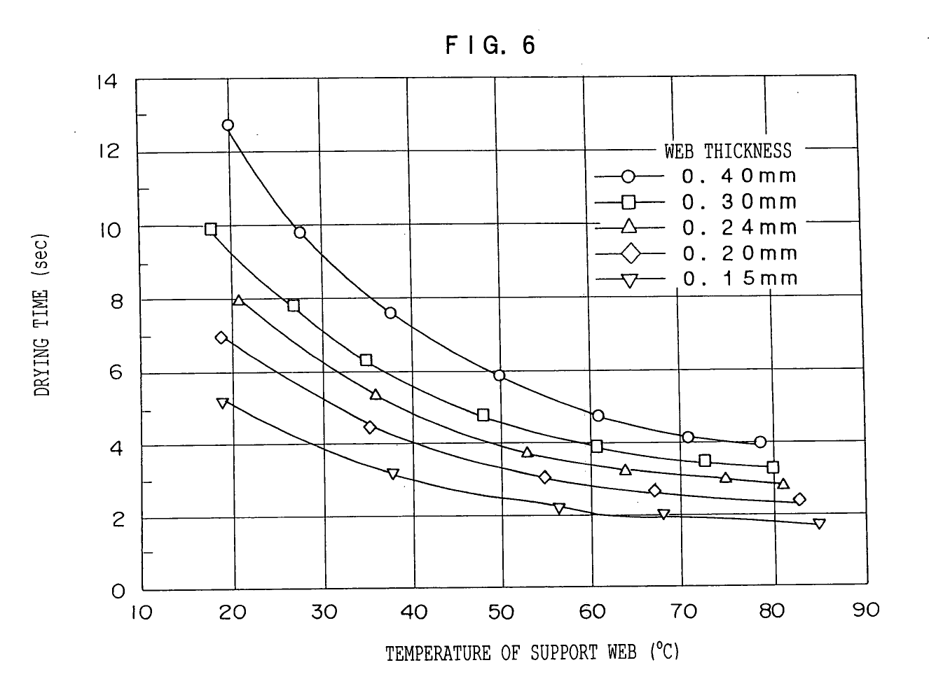

Results are shown in FIG. 6. Similarly to Example 3, also in Example 4, when the pre-heating temperature of the support web W was in the vicinity of 80° C., a slight trace caused by evaporation of the organic solvent was found in the thus obtained planographic printing plate; however, when a pre-heating temperature of the support web W was 70° C. or less, in the obtained planographic printing plate, there was hardly found such trace. Accordingly, it is found that a pre-heating temperature of a support web W is preferably 70° C. or less.

Here, among organic solvents contained in the photo-polymerizing type laser-sensitive layer forming solution, one that was the lowest in the boiling temperature was methyl ethyl ketone, and it's boiling temperature Tb_{low} is 80° C. Accordingly, 0.8Tb_{low} is 65° C., this conforms to the above results.

Furthermore, from FIG. 6, also in Example 4, similarly to Example 3, it is found that, when the surface temperature of the pre-heating roller 1 is varied, the drying time of the photosensitive layer forming solution can be increased or decreased without necessity of varying the temperature of the hot air and thus the drying time can be rapidly controlled.

As explained above, according to the present embodiment, a coating method that can be applied to manufacture a multi-layered planographic printing plate and allows manufacturing the planographic printing plate according to the embodiment at lower energy cost and running cost, and a planographic printing plate manufactured according to the coating method can be provided.

Furthermore, according to the invention, a coating method which can maintain a drying time of a coating solution such as a photosensitive layer forming solution constant, regardless of variation in width and a thickness of a web such as a support web, and a planographic printing plate manufactured according to the coating method can be provided.

1. A method of coating a coating solution comprising:
providing a web;
providing a coating solution;
coating the coating solution on at least one surface of the web; and
drying the coating solution to form a coated layer,
wherein a temperature of the web is maintained at 35° C. or more during coating.

2. The method of coating according to claim 1, wherein, when the coating solution is coated on at least one surface of the web, a temperature of the surface of the web is maintained in a range of 35° C. to 0.8 Tb_{low} (° C.), Tb_{low} being a boiling temperature in terms of centigrade lowest among boiling temperatures of solvents contained in the coating solution.

3. A method of coating according to claim 1, wherein the web is brought into contact with a heating roller to maintain a temperature at 35° C. or more.

4. The method of coating according to claim 1, comprising:
a first process of coating a first coating solution followed by drying, thereby forming a first coated layer; and
a second process of coating a second coating solution superposed on the first coated layer formed during the first coating process and subsequent drying, thereby forming a second coated layer superposed on the first coated layer,
wherein, during both the first and second coating processs, the first and second coating solutions are coated with a temperature of the web maintained at 35° C. or more.

5. The method of coating according to claim 4, wherein the first coating process includes a process of heating and drying the web on which the first coating solution has been coated, thereby forming a first coated layer; and
the second coating process includes a process of cooling the web heated and dried during the first coating process, thereby maintaining a temperature of a surface of the web at a temperature of 35° C. or more.

6. The method of coating according to claim 5, wherein the second coating process includes a process of applying cold air to a surface of the web on which the first coated layer has been formed during the first coating process, thus cooling the surface of the web.

7. The method of coating according to claim 1, wherein, in either a case where the web is wider than a predetermined value or a case where a thickness of the web exceeds a predetermined value, or in both such cases, the coating solution is coated with a temperature of the web maintained at a temperature of 35° C. or more.

8. The method of coating according to claim 7, wherein the coating solution is coated with a temperature of the web maintained at 0.8 Tb_{low} (° C.) or less.

9. A planographic printing plate, comprising:
a support web obtained by graining at least one surface of an aluminum web;
a plate-making layer formed on the grained surface of the support web; and
a protective layer that is superposed on the plate-making layer and protects the plate-making layer,
wherein the plate-making layer and the protective layer are formed by coating and drying respectively a plate-making layer forming solution and a protective layer forming solution, with a surface temperature of the support web maintained at a temperature of 35° C. or more.

10. The planographic printing plate according to claim 9, further comprising an intermediate layer located between the plate-making layer and the protective layer,
wherein the intermediate layer is formed by coating and drying an intermediate layer forming solution with the support web maintained at a temperature of 35° C. or more.

11. The planographic printing plate according to claim 10, wherein a temperature of the support web, when the intermediate layer forming solution is coated, is in a range of 35° C. to 0.8 Tb_{low} (° C.).

12. The planographic printing plate according to claim 10, wherein the intermediate layer is a layer having oxygen barrier properties.

13. The planographic printing plate according to claim 9, wherein, when both the plate-making layer forming solution and the protective layer forming solution are coated, a temperature of the support web is in a range of 35° C. to 0.8 Tb_{low} (° C.).

14. The planographic printing plate according to claim 9, wherein the plate-making layer is a photo-polymerizing type laser-sensitive layer that is polymerized by exposure to visible light or to ultra violet light, and the protective layer is an oxygen barrier layer that protects the photo-polymerizing type laser-sensitive layer from oxygen in the air.

15. A planographic printing plate, comprising:
a support web obtained by graining at least one surface of an aluminum web; and
a plate-making layer formed on the grained surface of the support web,
wherein the planographic printing plate is formed by coating the coating solution in either a state where a web is wider than a predetermined value, or in a state where the web is thicker than a predetermined value, or in both such states, and with a temperature of the web of the plate-making layer maintained at a temperature of 35° C. or more.

16. The planographic printing plate according to claim 15, wherein the plate-making layer is formed by coating a plate-making layer forming solution on a support web maintained at a temperature of between 35° C. and 0.8 Tb_{low} (° C.), and thereafter drying the support web.

17. The planographic printing plate according to claim 15, wherein the plate-making layer is a photo-polymerizing type laser-sensitive layer that is polymerized by exposure to visible light or to ultra violet light.

18. The planographic printing plate according to claim 17, further comprising an oxygen barrier layer that protects the photo-polymerizing type laser-sensitive layer from oxygen in the air,
wherein the oxygen barrier layer is superposed on the photo-polymerizing type laser-sensitive layer.

19. The planographic printing plate according to claim 18, wherein an intermediate layer of an oxygen barrier resin is formed between the photo-polymerizing type laser-sensitive layer and the oxygen barrier layer.
